(19) United States
(12) Patent Application Publication
(10) Pub. No.: US 2006/0254834 A1
(43) Pub. Date: Nov. 16, 2006

(54) Method and apparatus for moving a bed

(76) Inventors: Alfred Dassler, Hollywood, FL (US); Eric Hoffman, Davie, FL (US); Scott Smiley, Fort Lauderdale, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 11/127,689

(22) Filed: May 11, 2005

(51) Int. Cl. B62M 7/14

(52) U.S. Cl. 180/11

(57) ABSTRACT

A bed moving device includes a two part frame with the lower section having a motor and at least one driving wheel. The upper section rotates independent of the lower section and includes at least one suction device for attachment to a headboard or footboard of a bed and a set of controllers for directing the speed and direction of the motor and for directing a direction of the bed. The motor supplies the driving force to move the device and bed.

### BACKGROUND OF THE INVENTION

1. Field of the Invention

This invention relates in general to relocation of hospital beds and more particularly, to a motorized apparatus that quickly attaches to a variety of bed-frame designs and moves the bed from one place to another.

2. Description of the Related Art

While the health of the patients is the top priority of a hospital, the safety of its employees runs a close second. With insurance rates constantly on the rise, preventing employee injuries not only makes common sense, it makes financial sense as well. One steady source of injury stems from lifting, pushing, or pulling heavy objects.

If a patient must stay overnight in a hospital, he or she is assigned to a room and, accordingly, to a bed. It is quite common, however, for a patient to be relocated to a different location. For instance, a patient may need to have tests or procedures performed, and while some test equipment is mobile, other equipment is not. Therefore, the patient will have to be transported to a specific area of the hospital for the tests to be performed. Similarly, a patient may be reassigned to a different room. For instance, a patient in critical condition will be in a critical care section of the hospital, where he can receive a high level of supervision and care, and, after improving from a critical condition where such close supervision is no longer needed, will be relocated to a different section of the hospital. There are a variety of other reasons why a patient might need to be relocated.

Hospital beds are generally quite large and consist of a metal frame, a mattress, a headboard, a foot board, and mechanics to raise and lower the height of the bed and to adjust the angle of at least the portion supporting the patient's upper body. Numerous manufactures compete in the hospital bed market, resulting in a multitude of bed-frame designs being present in a single hospital facility. Due to the previously-mentioned structure, all of the beds are generally are quite heavy and can weigh as much as 600 lbs.

Relocating such a heavy structure can place significant strain on the persons assigned to transporting the bed. The result of pushing and pulling the bed, especially over time, can cause serious back and other related injuries. To combat this problem, several beds on the market are equipped with a motor to assist the operator in relocating the bed. The beds are very expensive however, costing as much as $45,000 each. Even if the price weren't so cost prohibitive, the fact remains that the hospitals are fully stocked with beds with no motors.

Attempts have been made at providing a motorized apparatus that is portable and can be attached to a bed frame. However, due to the large variety of bed designs found in the field, prior art apparatus' have the disadvantage that they do not provide a satisfactory solution for attaching to and moving a majority of bed-frame designs in a hospital or any health care facility.

Furthermore, physical space in hospital rooms, hallways, and elevators is limited. Prior-art apparatus' that attach to bed frames extend from one of the ends of the bed and greatly extend the total length, making maneuverability of the bed and apparatus difficult.

Accordingly, a need exists for a compact motorized apparatus that has the flexibility to be easily attached to hospital-type beds manufactured by a variety of manufacturers having varying designs, and that is capable of being easily operated to move the beds from one location to another.

### SUMMARY OF THE INVENTION

Briefly, in accordance with the present invention, disclosed is a apparatus for moving a hospital-type bed from one physical location to another. The apparatus includes a set of balancing wheels and at least one driving wheel for applying force to the floor. The driving wheel is driven by an electric motor, which draws its energy from a battery. Preferably, the battery source is rechargeable, but does not necessarily have to be. The wheels, motor, and battery are all attached to a lower section of a two-piece body. Also attached to the lower section holding the wheels, motor and battery is a steering handle, which includes driving controls, such as forward, backward, stop, speed controls, and others.

At the upper section of the two-piece body is one or more cup-shaped elements operable to apply a suction force for securely attaching the apparatus to either a headboard or a footboard of a hospital bed. The two body pieces are rotatably connected to each other so that the steering handle can be used to rotate the lower section thereby turning the balancing and driving wheels in relation to the upper section, which remains fixedly attached to the headboard or footboard that it is suctioned to.

In the manner briefly discussed above, as well as other embodiments that will be described below and that will be apparent from the present invention, a apparatus for moving a hospital bed can be realized.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating one embodiment of a hospital bed;

FIG. 2 is a diagram illustrating a side-elevational view of a motorized bed-moving apparatus, according to one embodiment of the present invention;

FIG. 3 is a diagram illustrating a plan view of a motorized bed-moving apparatus, according to one embodiment of the present invention;

FIG. 4 is a diagram illustrating the bed-moving apparatus of FIGS. 2 and 3 attached to the hospital bed of FIG. 1, according to one embodiment of the present invention;

FIG. 5 is a diagram illustrating a suction device according to one embodiment of the present invention; and

FIG. 6 is a diagram illustrating a coupling system of the motorized bed-moving device according to one embodiment of the present invention.

FIG. 7 is a diagram illustrating a bed-moving device including the coupling system of FIG. 6 according to one embodiment of the present invention.

FIG. 8 is a flow diagram illustrating a method for moving a bed according to one embodiment of the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

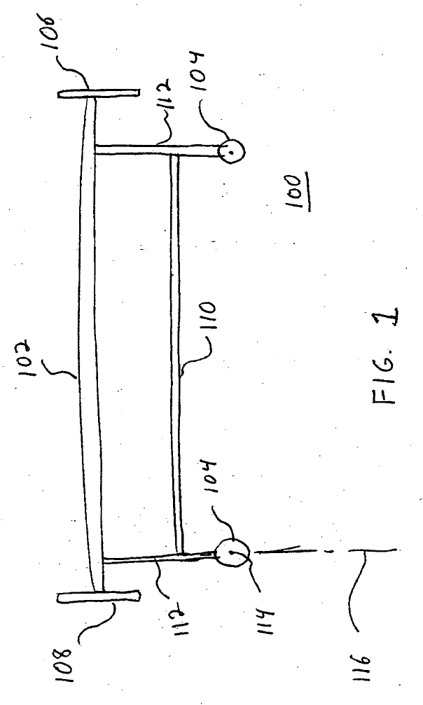

Referring now to FIG. 1, a hospital bed 100 is shown. The hospital bed 100 shown in FIG. 1 is typical of many hospital beds found in hospitals, nursing homes, residential home, and more, and is commonly used in the health-care industry. Hospital bed 100 includes a patient support surface 102 where a patient is able to lie prone. In many beds, the patient support surface 102 can be raised, lowered, tilted, or only a portion of the surface 102 can do the same. Depending on the sophistication of the particular bed, the patient support surface 102 can be repositioned either manually, by pressing one or more foot pedals located near the floor for easy reach of a user's foot, or with a series of electric motors, which can also be actuated by pressing foot pedals, or, alternatively, by pressing buttons provided at various locations along the bed.

The patient support surface 102 is supported by at least two pairs of legs 112, provided with a friction abating, rotating castor 104 at the end of each leg 112. Castors 104 are attached to the legs 112 of bed 100 in such a manner as to rotate on a horizontal center axis 114 perpendicular to the vertical axis 116 of the leg 112. At least two of the four castors 104 are pivotally attached to the legs 112 so that the castors 104 can pivot around the vertical axis 116 of each leg 112. In many beds, all four castors are pivotally attached to their respective legs allowing all four to pivot when a lateral force is applied to the bed. The rotating pivoting castors allow the bed to be pushed in almost any direction when a force is applied to the bed.

Most hospital beds 100 are provided with a headboard 106 at one end of the bed and a footboard 108 at the other. The head and footboards are generally well secured to the bed 100 and extend in a vertical direction both above and below the patient support surface 102, as shown in FIG. 1. Among other functions, the headboard and footboard provide a location for an operator to apply pushing force to the bed when transporting a patient from one location to another.

Because hospital beds are required to handle patients of relatively large size when required, the framework must be of sufficient size to support the load of the patient. Additionally, the motors, pedals, mattress, and other features of the bed add to the total weight. As a result, it is not uncommon for the total weight of the bed and patient to exceed 700 lbs. Starting and stopping a large load requires a great deal of force applied to the bed. This required force is increased when the pivoting castors are not initially aligned with the direction the bed is to be moved.

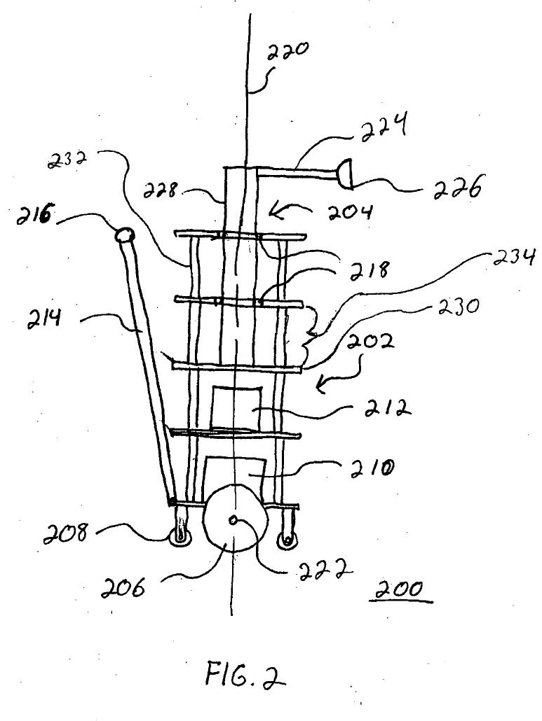

Referring now to FIG. 2, a bed-moving apparatus 200 is shown. The apparatus 200 includes two sections: a lower section 202 and an upper section 204. The lower section 202 includes a plurality of plates 230 connected by supports 232. The supports 232 can be posts, tubes, walls, or other similar structures. The supports 232 can pass through multiple plates, extend between only two plates, be in staggered alignment, or combinations thereof so as to allow easy assembly and manufacture of the apparatus 200. Each set of plates 230 defines a subsection 234 within the apparatus 200. The subsections 234 are aligned in a vertical orientation.

Additionally, the lower section 202 is provided with bearings 218 disposed within one or more of the plates 230. The upper section 204 rotates within the bearings 218 upon an axis 220 through the center of the apparatus 200. Bearings 218 allow the upper section 204 to remain in physical communication with the lower section 202 while being able to rotate with respect to the lower section 202.

In one embodiment, the upper section 204 and lower section 202 are coupled by a spring-type mechanism for allowing the lower and upper sections to move relative to one another. For instance, when rolling over a doorway threshold, the upper section 204, attached to the bed, can remain stationary while the lower section 202 compresses the spring, moves over the threshold and relative to the upper section 204, and then back to its original position.

The lower section 202 of the apparatus 200 has a set of driving wheels 206 that make contact with the ground. The driving wheels 206 are connected by a drive shaft/axle 222. The driving wheels 206 are selected from a material that provides sufficient friction to the floor surface, which is often a waxed linoleum or other smooth polished surface. A set of wheels or castors 208 are also attached to the lower section 202 of the apparatus 200 and provide, in conjunction with the driving wheels 206, stability to the apparatus 200, so that the apparatus 200 can stand upright without falling over. The castors 208 work similarly to the castors 104 described above and allow the lower section 202 of the apparatus 200 to turn freely upon an axis 220 through the center of the apparatus 200 while the upper section 204 remains fixedly attached to the headboard.

The wheels 206 are driven by a motor 210 located within the lower section 202 of the apparatus 200. In one embodiment, the motor is a standard DC motor that is well known by those of ordinary skill in the art. The motor 210 can be directly connected to a driveshaft/axle 222, or can drive the drive shaft/axle 222 through at least one provided gear (not shown). Preferably, the motor 210 can be operated in forward and reverse directions. Power for the motor 210 is provided by a battery 212, also located within the lower section 202 of the apparatus 200 and electrically connected to the inputs of the motor 210. In a preferred embodiment, the battery is a standard rechargeable DC battery. A variety of motors and batteries, each having varying electrical characteristics, can be selected to perform the function of moving the apparatus, and, as will be explained below, a bed. It is a goal of the motor and battery combination to provide enough driving power and operation time to perform multiple bed relocations before needing to be recharged.

The upper section 204 of the apparatus 200 includes a vertically oriented, elongated section 228 that rotates with respect to the lower section 202, as described above. The upper section 204 rotates within the bearings 218 located within the plates 230 provided in the lower section 202. In one embodiment of the present invention, an end of the elongated section 228 rests on one of the plates 230 and the elongated section 228 has a conical or spherical radius to allow rotation of the elongated section 228.

The upper section 204 is also provided with a pair of horizontal arms 224 physically coupled to the elongated section 228 and to at least one suction cup 226. A suction cup 226 is an apparatus that can apply a suctional force to any substantially flat surface and is generally well known to those of skill in the art. As will be explained in greater detail below, it is through the suction cup 226 that the apparatus 200 can be attached to the hospital bed 100. The suction cup 226 can hold and release a suctional force. For example, the suction can be applied by a mechanical lever, a vacuum, or other similar method. The horizontal arms 224 may have a spring-loaded construction allowing the suction cups to accommodate deviations in the headboard.

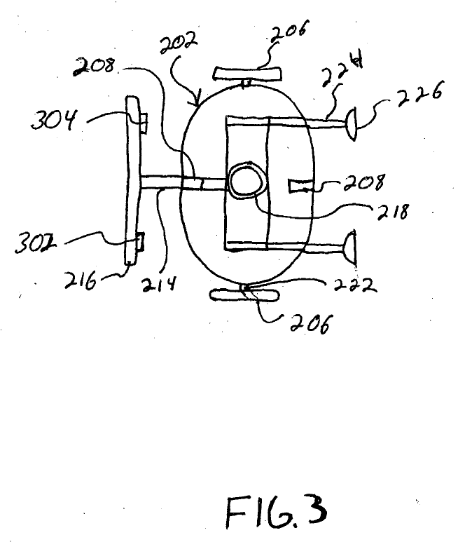

FIG. 3 shows a plan view of the bed-moving apparatus 200. In FIG. 3, rotational bearings 218 can be seen, as well as the set of horizontally oriented extending arms 224 attached to the suction cups 226. The plan view of FIG. 3 also shows the orientation of driving wheels 206 and balancing castors 208.

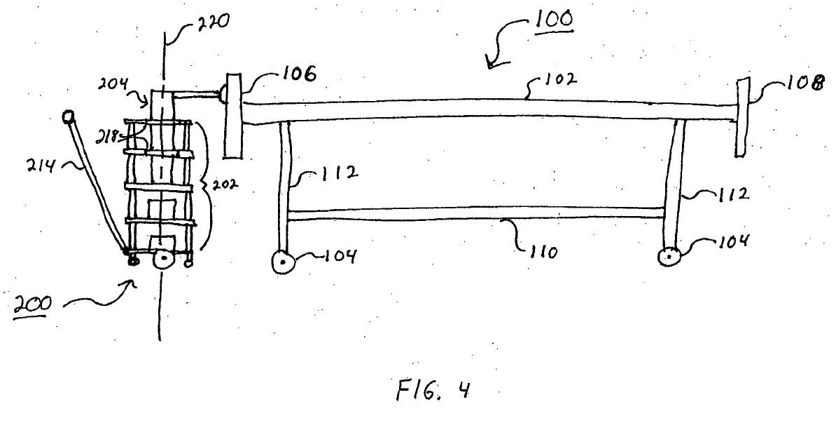

Most hospital beds of the kind described above have headboards and footboards that are substantially smooth and flat. Looking now to FIG. 4, the bed-moving apparatus 200 is attached to the headboard 106 of a bed 100 by suction cups 226. When attached to apparatus 200, in the manner shown in FIG. 4, the upper section of the apparatus is fixedly attached to the headboard 106 and remains locked to the headboard 106. Because the bottom section 202 of the apparatus 200 is provided with bearings 218, the bottom section can pivot around the center axis 220 while the upper section 204 remains attached to the headboard 106. Referring back to FIG. 2, the apparatus 200 is seen with a steering handle 214 attached to the bottom section 202. The handle 214 provides an easy way for an operator to rotate the bottom section 202 in relation to the bed 100 and direct the direction of the movement of the bed. To make use of the handle easier, a grip 216 is provided at the end of the handle 214. The grip, which can also be seen in FIG. 3, can have a set of controls 302, 304 for engaging the motor in the forward or reverse directions. In one embodiment, the motor 210 can be connected to the wheels 206 so that the wheels 206 spin in opposite directions to facilitate tight turns.

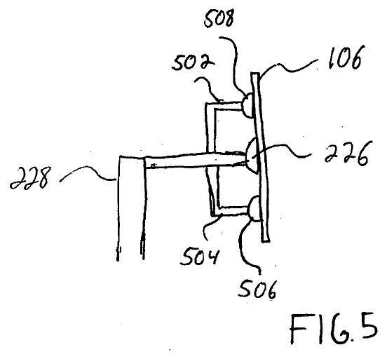

FIG. 5 shows one embodiment of the bed-moving apparatus 200. In the embodiment shown, an extra pair of arms 502 and 504 are attached to the elongated section 228. The arms can be provided with suction cups, elastomeric stoppers, or other support materials. For exemplary purposes, a pair of suction cups 508 and 506 are shown in FIG. 5. The suction cups 508 and 506 at the end of the arms provide added attachment strength to the apparatus. The extra arms 502 and 504 help prevent movement or separation of the apparatus 200 in relation to the headboard 106 or footboard 108 of bed 100 that the apparatus 200 is attached to.

Because not all head and footboards present a smooth surface area in which to attach the suction cups, an area of smooth material can be applied to the head or footboard of individual beds in a facility. In one embodiment, a sticker is used, which is a piece of smooth material having an adhesive backing, and can be easily attached to the bed.

In the manner described above, and referring back to FIG. 2, the apparatus 200 can be securely attached to a bed 100 and through the use of the handle 214 and grip 216, power can be sent to the drive wheels 206. Movement of the handle 214 will allow the bed to be pushed or pulled in any direction while reducing the need for an operator to apply their own physical force to the bed.

Modifications of the exemplary embodiments described in the figures of the instant application lie entirely within the scope of the invention. For example, instead the elongated section 228 of the upper section 204 rotating within the bearings that are disposed in the lower section 202, it is also possible for the elongated section 228 to be fixed with respect to the lower section 202 on one of the plates 230 and for the bearings to be mounted in a plate or connection 604 that connects the horizontal arms 224 to the elongated section 228.

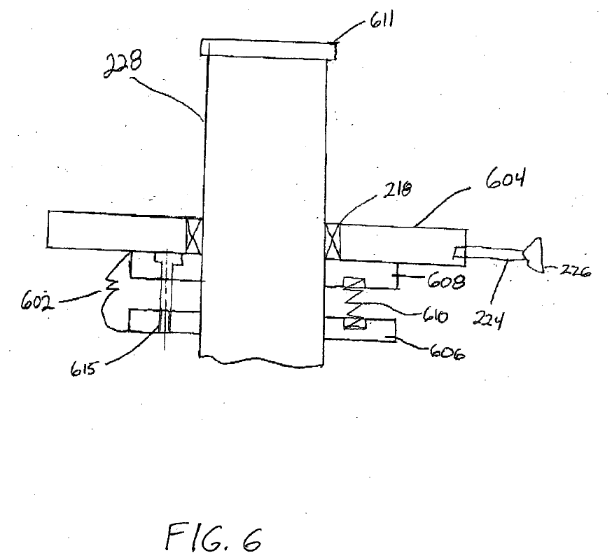

Referring now to FIG. 6, a collar assembly 602 vertically positions and holds the plate or connection 604 on the elongated section 228. The collar assembly 602 includes two collars 606 and 608 that are mechanically, by bolts, screws, or the like, connected to each other and have springs 610 disposed between each other so that the collars 606 and 608 have a light spring force pushing each other apart. The lower of the two collars 606 is statically mounted to the elongated section 228. This allows the upper collar 608 to move vertically with respect to the lower collar 606. The collar assembly 602 permits the plate or connection 604 to move vertical on the elongated section 228 so as to accommodate any deviations in the surfaces over which the beds are moved. This in turn ensures that at least one suction cup 226 will maintain a connection with the bed 100 without dislodging the headboard 108 or footboard 106. In one embodiment of the present invention, a removable collar 611 is provided so as to prevent the plate or connection 604 from separating from the elongated section 228.

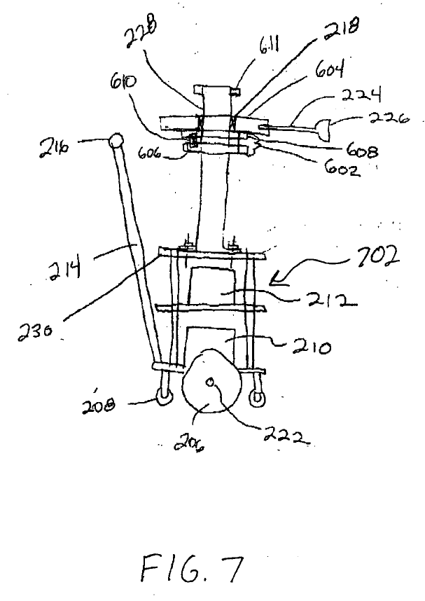

FIG. 7 shows the assembly of FIG. 6, including the elongated section 228, attached to a lower section 702. Lower section 702 includes at least one driving wheel 206 and a stabilizing wheel 208. The lower section also includes a steering handle 214. The handle 214 provides an easy way for an operator to rotate the lower section 702 in relation to a bed and direct the direction of the movement of the bed. To make use of the handle easier, a grip 216 is provided at the end of the handle 214. The grip can have a set of controls for engaging the motor in the forward or reverse directions. In one embodiment, a motor 210 can be connected to the wheels 206 so that the wheels 206 spin in opposite directions to facilitate tight turns.

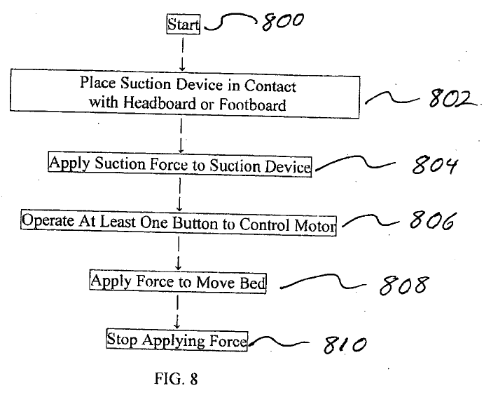

Referring now to FIG. 8, a flow diagram for the present invention is shown. The flow begins at step 800 and moved directly to step 802 where at least one suction device is placed in contact with either a headboard or a footboard of a bed. In step 804, a suction force is applied to the suction device, creating a negative pressure between the suction device and the bed. Next, in step 806, at least one button is operated to control a motor attached to the suction device. Finally, in step 808, a force is applied to the suction device by the controlled motor, thereby moving the bed. The flow ends at step 810, where force is no longer applied to the bed.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A apparatus for moving a bed comprising:
a motor;
a power supply providing power to the motor;
at least one driving wheel in physical communication with the motor;
at least one suction device securing the apparatus to a bed;
a first controller controlling at least one of a speed of the motor and a direction of rotation of the motor; and
a second controller controlling a direction of the driving wheel.

2. The apparatus according to claim 1, wherein the power supply is a battery.

3. The apparatus according to claim 1, wherein the suction apparatus is a suction cup having a controllable vacuum.

4. The apparatus according to claim 1, wherein the bed is a hospital bed.

5. The apparatus according to claim 1, wherein the bed has at least one of a headboard and a footboard.

6. The apparatus according to claim 5, wherein the suction device is operable to apply a continuous suction to at least one of the headboard and footboard of the bed.

7. The apparatus according to claim 1, wherein the first controller is an electrical switch for applying power in at least one polarity to the motor.

8. The apparatus according to claim 1, wherein the second controller is a mechanical arm.

9. The apparatus according to claim 1, wherein the apparatus further comprises:
an upper section coupled to the at least one suction device; and
a lower section coupled to the at least one driving wheel,
wherein the upper section and lower section are rotatable in relation to each other.

10. A method for moving a bed, the method comprising the steps of:
placing at least one suction device in contact with at least one of a headboard and a footboard of a bed;
applying a suction force, with the at least one suction device, to the at least one of a headboard and a footboard so that the at least one suction device and the at least one of a headboard and a footboard are attached to each other; and
causing a force to be applied to the at least one suction device, thereby moving the at least one suction device and the bed.

11. The method according to claim 10, wherein the at least one suction device includes at least one suction cup.

12. The method according to claim 10, wherein the force is a lateral force.

13. The method according to claim 10, wherein the force is applied by a motor and at least one driving wheel in contact with a floor.

14. The method according the claim 13, further comprising operating at least one switch to control the motor.

15. The method according to claim 10, further comprising the step of:
directing a direction of the movement of the at least one suction device and the bed.
